(19) United States
(12) Patent Application Publication
(10) Pub. No.: US 2008/0308067 A1
(43) Pub. Date: Dec. 18, 2008

(54) Method for ascertaining a quality characteristics of a diesel fuel

(76) Inventors: Marko Schuckert, Stuttgart (DE); Sanl Dzeko, Frankfurt (DE); Liwel Jin, Gerlingen (DE); Herbert Schumacher, Gerlingen (DE)

Correspondence Address: KENYON & KENYON LLP, ONE BROADWAY, NEW YORK, NY, 10004, US

(21) Appl. No.: 12/157,208

(22) Filed: Jun. 6, 2008

(30) Foreign Application Priority Data
Jun. 14, 2007 (DE) 102007027483.3

(51) Int. Cl. F02D 41/00

(52) U.S. Cl. 123/435

(57) ABSTRACT

A method for ascertaining a quality characteristic of a Diesel fuel for a Diesel internal combustion engine, having a device for determining the cylinder pressure curve of at least one cylinder, a process variable of the combustion being ascertained from the cylinder pressure curve, which characterizes the fuel quality.

### FIELD OF THE INVENTION

The present invention relates to a method for ascertaining a quality characteristic of a Diesel fuel for a Diesel internal combustion engine having a device for determining the cylinder pressure curve of at least one cylinder.

### BACKGROUND INFORMATION

The quality of a fuel for a Diesel internal combustion engine is essentially characterized by the ignition retard and the fuel burn-through speed. By ignition retard one should understand the time from the beginning of injection into the cylinder of an engine until the actual initiation of combustion of the air-fuel mixture. The ignition retard is a function of various factors, especially the ignition performance, which is described by the cetane number, but also of operating parameters of the internal combustion engine, such as the temperature in the combustion chamber, the pressure in the combustion chamber and the type of mixture formation, which may be influenced, for instance, by the nozzle (distribution of droplet size in the fuel jet) or the air guide (e.g. valves having a deflector in the intake, tangential flow channels, the shape of the piston floor, etc.). The fuel burn-through speed is the speed at which the fuel/air mixture burns off, for example, the time period between the beginning of combustion and the achievement of a certain combustion conversion.

No method is known from the related art which makes possible a determination of the quality characteristics of the fuel used in the operation of an internal combustion engine.

### SUMMARY OF THE INVENTION

It is an object of the present invention to provide a method which supplies a measure for the fuel quality of the fuel used.

This object is attained by a method for ascertaining a quality characteristic of a Diesel fuel for a Diesel internal combustion engine having a device for determining the cylinder pressure curve of at least one cylinder, a process variable of the combustion being ascertained from the cylinder pressure curve which characterizes the fuel quality. This process variable is preferably the distance between the point of injection and the combustion center point and/or the distance between the point of injection and the time of the maximum of the heat-release development. Both variables may be ascertained with sufficient accuracy from the cylinder pressure curve and perhaps additional measured or modeled parameters. The process variable is preferably corrected by a correction value that is a function of environmental conditions of the internal combustion engine, especially a function of the environmental temperature and/or the environmental pressure and/or the engine temperature and/or an additional torque requirement of auxiliary assemblies of the internal combustion engine. This measure increases the reproducibility of the ascertainment of the quality characteristic.

The ascertainment of the quality characteristic enables an adaptation of operating parameters, for instance, by characteristics map switchovers, change of constant parameters or the like, for the equalization of different fuel characteristics. The characteristics of the fuels at different tank fillings of a motor vehicle may thus be compensated for, unnoticed by the driver. By using cylinder pressure characteristics, which take into account both the ignition retard and the fuel burn-through speed, conclusions may be drawn regarding the fuel characteristics.

The ascertainment of the process variable preferably takes place during a test operation under defined boundary conditions, the defined boundary conditions including the crankshaft speed and/or the load and/or the supercharging pressure and/or the exhaust gas recirculating rate and/or the injection pressure. The influence of interference variables on the determination of the quality characteristics is reduced by this measure.

It is preferably provided, during the test operation, that single fuel injections be deposited. This makes the influence of the quality characteristic of the Diesel fuel for the observed process variable particularly well visible.

The problem mentioned at the outset is also resolved by a device, particularly a control unit or internal combustion engine, which is arranged for carrying out the method according to the present invention, as well as a computer program having program code for carrying out all the steps of a method according to the present invention, when the program is executed on a computer.

### BRIEF DESCRIPTION OF THE DRAWING

FIG. 1 shows a flow chart of an exemplary embodiment of a method according to the present invention.

### DETAILED DESCRIPTION

For the following exemplary embodiment, we assume a direct-injection Diesel engine as the internal combustion engine, having a device for determining the cylinder pressure curve of at least one cylinder. This device may be a cylinder pressure sensor of a guide cylinder, for example, but it is also possible to determine the cylinder pressure curve in a model-based manner via a rotational speed signal. The internal combustion engine is now operated in a test mode, designated also as fuel detection mode (FDM), in which the internal combustion engine is operated under defined boundary conditions such as, for instance, a specified rotational speed, a specified load, a specified supercharging pressure, a specified exhaust gas recirculation rate, a specified injection pressure, etc.

The specified operating state of the test operation should be frequently brought up in the life cycle of a vehicle, so as to make possible a regular control of the fuel. That is why, for example, idling or lower part throttle range are very meaningful as operating state, but in theory, every other frequently occurring rotational speed/load point is possible as test operation. The values for the fuel quality ascertained in the test operation are then used as input variables for the targeted application adjustment, for instance, by correction characteristics maps for control beginning, rail pressure, exhaust gas recirculation rate and the like.

The cylinder pressure curve is evaluated in the test operation as a defined operating state (fuel detection mode, FDM) of the directly injecting Diesel engine. In the evaluation, a characteristic is selected which represents a combination of ignition retard and fuel burn-through speed. The aim is to generate a characteristic fuel characteristic number. The following characteristics satisfy these criteria:
1. The distance T_MFB50 between point of injection SoE and combustion center point MFB50;
2. the distance T_dQmax between point of injection SoE and the time of the maximum of heat release development dQmax.

Since the internal combustion engine is not always operated under the same environmental conditions, during the test operation, it is necessary to correct the ascertained distances T_MFB50 and T_sQmax. The correction parameters are the environmental temperature, the environmental pressure, the engine temperature and an additional torque requirement by users (such as the air conditioning system, lights, etc.) in the vehicle.

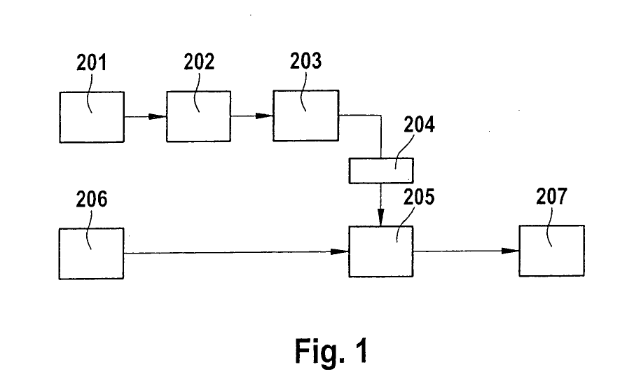

FIG. 1 shows a flow chart of an exemplary embodiment of a method according to the present invention. In step 201, first of all a switchover to test operation takes place, and then, in step 202, the cylinder pressure curve is measured. In step 203 there follows an evaluation of the cylinder pressure curve, and in step 204, from the evaluation of the cylinder pressure curve, there follows the determination of the point of injection SoE, the combustion center point MFB50, the maximum of the heat-release development dQmax, as well as the distance T_MFB50 between point of injection SoE and the combustion center point MFB50, as well as the determination of the distance T_dQmax between the point of injection SoE and the time of the maximum of heat-release development dQmax. In step 205, these characteristics, that were determined before, are corrected with the aid of correction values that were determined previously in a step 206. In step 207 a recalculation takes place of the values to form fuel properties, using the corrected values, ascertained in step 205, for SoE, MFB50, dQmax, as well as T_MFB50 and T_dQmax.

What is claimed is:

1. A method for ascertaining a quality characteristic of a Diesel fuel for a Diesel internal combustion engine, the method comprising:
determining a cylinder pressure curve of at least one cylinder of the engine; and
ascertaining a process variable of a combustion as a function of the cylinder pressure curve, which characterizes the fuel quality.

2. The method according to claim 1, wherein the process variable is a distance between a point of injection and a combustion center point.

3. The method according to claim 1, wherein the process variable is a distance between a point of injection and a time of a maximum of a heat-release development.

4. The method according to claim 1, further comprising correcting the process variable by a correction value that is a function of environmental conditions of the internal combustion engine.

5. The method according to claim 4, further comprising ascertaining the correction value as a function of at least one of an environmental temperature, an environmental pressure, an engine pressure and an additional torque requirement by auxiliary assemblies of the internal combustion engine.

6. The method according to claim 1, wherein the ascertainment of the process variable takes place during a test operation under specified boundary conditions.

7. The method according to claim 6, wherein the specified boundary conditions include at least one of a crankshaft speed, a load, a supercharging pressure, an exhaust gas recirculation rate, an injection pressure and a beginning of injection.

8. The method according to claim 6, further comprising depositing single injections during the test operation.

9. A device for ascertaining a quality characteristic of a Diesel fuel for a Diesel internal combustion engine, comprising:
means for determining a cylinder pressure curve of at least one cylinder of the engine; and
means for ascertaining a process variable of a combustion as a function of the cylinder pressure curve, which characterizes the fuel quality.

10. The device according to claim 9, wherein the device is a control unit.

11. A computer-readable medium containing a computer program which when executed by a processor performs the following method for ascertaining a quality characteristic of a Diesel fuel for a Diesel internal combustion engine:
determining a cylinder pressure curve of at least one cylinder of the engine; and
ascertaining a process variable of a combustion as a function of the cylinder pressure curve, which characterizes the fuel quality.
